(19) United States
(12) Patent Application Publication
(10) Pub. No.: US 2024/0286801 A1
(43) Pub. Date: Aug. 29, 2024

(54) Closure for a Container with an Indication of Whether the Closure has Already Been Opened, and Different Applications for Said Closure

(71) Applicant: SIG Services AG, Neuhausen am Rheinfall (CH)

(72) Inventor: Daniel C. Bucher, Neunkirch (CH)

(21) Appl. No.: 18/563,317

(22) PCT Filed: May 30, 2022
(86) PCT No.: PCT/EP2022/064604

§ 371 Date: Nov. 21, 2023

(30) Foreign Application Priority Data
Jun. 3, 2021 (EP) 21020295.8

(51) Int. Cl. B65D 41/34; B65D 41/36; B65D 55/16

(52) U.S. Cl. CPC B65D 41/3428; B65D 41/36; B65D 55/16; B65D 2401/30

(57) ABSTRACT

Closure for a container, in particular a bottle or a cardboard/plastic composite package, with a base element including a rotatably opening closure with lateral cap jacket, an anchor ring connected to the closure cap by means of a hinge element and a free gap running substantially in the circumferential direction between the anchor ring and cap jacket wherein the free gap connects on both sides next to the hinge element and wherein there are no material bridges between the anchor ring and closure cap in the free gap that can break on initial opening. To achieve low, constant and well controlled opening forces on first opening in a closure of this type, it is provided for the closure to have a tamper-evident seal which, in the unopened state, is connected to the anchor ring via at least one breakable element and by the tamper-evident seal on the anchor ring being designed in such a way that the at least one breakable element is broken after a relative rotational movement between the closure cap and container of a maximum of 25°.

### CROSS REFERENCE TO RELATED APPLICATIONS

This application is the United States national phase of International Patent Application No. PCT/EP2022/064604 filed May 30, 2022, and claims priority to European Patent Application No. 21020295.8 filed Jun. 3, 2021, the disclosures of which are hereby incorporated by reference in their entireties.

### BACKGROUND OF THE INVENTION

### Field of the Invention

The invention relates to a closure for a container, in particular a bottle or a cardboard/plastic composite package, with a base element comprising a rotatably opening closure with lateral cap jacket, an anchor ring connected to the closure cap by means of a hinge element and a free gap running substantially in the circumferential direction between the anchor ring and cap jacket, wherein the free gap connects on both sides next to the hinge element and wherein there are no material bridges between the anchor ring and closure cap in the free gap that can break on initial opening.

### Description of Related Art

A prior closure is known from DE 20 2019 106 992 U1 and DE 20 2019 106 993 U1 that can be traced back to the applicant. In order to ensure that the closure caps of containers do not unintentionally enter the environment, it is desirable to securely attach closure caps to their respective containers so that loose plastic parts are reliably avoided even after opening. This solution is combined here in a pouring element that can be reclosed with the closure by a clearly visible, tamper-evident seal attached outside the anchor ring.

A closure device for a PET bottle with a ring arranged under the closure cap is known from EP 1 124 734 B1, said ring being connected to the closure cap via a film hinge and preventing the closure cap from being pulled off even in the opened state.

WO 2020/227 813 A1 shows a closure cap for a bottle with a ring arranged under the closure cap, which is connected to the closure cap via two connecting bridges. The ring and the bottle are designed in such manner that the ring cannot be pulled off the bottle. Various types of hinge elements are shown here, such as a central tab with hinge parts on both sides or a Y-shaped hinge part consisting of two arms interrupted at the cap jacket.

Furthermore, a screw closure for a conventional bottle is known from WO 2020/041 640 A2. The screw cap consists of a closure cap and a ring connected via a hinge element. Here too, the ring ensures that the screw closure is connected in a tension-resistant manner to the bottle in the axial direction and is additionally a tamper-evident seal.

Elements which ensure a secure fastening of closure caps to their respective package even in the opened state have long been known from the prior art, particularly as described above in the area of closures for commercially available PET bottles. The connection itself is also used directly as a tamper-evident seal, for example by attaching breakable material bridges between the closure cap and the connection, which are intended to indicate an initial opening if they are broken. Using such breakable material bridges as tamper-evident seals is nowadays a matter of course, even if they are not always depicted in figures for simplicity. Unfortunately, the design of such elements is severely limited because they are directly related to the connection.

It can rarely be guaranteed that the tamper-evident seal will be broken within a clearly defined frame if the corresponding breakable material bridges are not attached to a stable location of the closure and instead, for example, between two elements that are unevenly pulled apart on initial opening. These are usually formed between the cap jacket and the element arranged below. The underlying element can then be roughly divided into different parts, such as connection arms, wherein one of them runs clockwise and the other counterclockwise, and the main part of the anchor ring, which are subjected to completely different forces during the initial opening. One of the arms is pulled over the cap jacket while the other is pushed and a mixture of forces acts on the areas in between. Accordingly, the material bridges also break in an unpredictable way, if all of them even break.

It is also desirable that the closure cap and anchor ring remain as freely rotatable as possible. A radial adjustment of the screw cap to a locked opening position is advantageous here in order to enable pouring from any direction of the container neck, particularly in the case of asymmetrical containers. Therefore, the tamper-evident seal cannot simply be broken by blocking the anchor ring, which could reduce at least some of the problems mentioned above.

On this basis, the object of the present invention is to design and further develop a closure for a container of the type mentioned at the outset in such a way that the aforementioned disadvantages are overcome. In particular, a rapid breaking of the tamper-evident seal of the closure should be achieved during the initial opening. The forces required by the consumer to open a container initially should be as low as possible and as steady as possible over the largest possible rotation range. The differences in opening forces between individual containers should also be kept as low as possible.

This object is achieved with a closure having the features described herein by the closure comprising a tamper-evident seal which, in the unopened state, is connected to the anchor ring via at least one breakable element and wherein the tamper-evident seal on the anchor ring being designed in such a way that the at least one breakable element is broken after a relative rotational movement between the closure cap and container of a maximum of 25°.

The closure according to the invention comprises a tamper-evident seal which, in an unopened state, is connected to the anchor ring via at least one breakable element. Comparable solutions with an additional tamper-evident seal but in combination with breakable material bridges in the free gap are already known from the previously cited DE 20 2019 106 992 U1 or also WO 2021/063 669 A1, which deals specifically with the breakable material bridges in the various free gaps. However, the combination of a tamper-evident seal on the anchor ring and a free gap without predetermined fracture points makes it possible to tackle the problems mentioned in the object at the same time. For example, a tamper-evident seal can be used, which is blocked very quickly when the closure cap is rotated and thus causes the at least one predetermined fracture point to break. Because the tamper-evident seal is blocked independently of the anchor ring, the anchor ring is still freely rotatable and independent of the elements to be broken. The more clearly defined states around the at least one breakable element ultimately allow better control over the progression of forces when the entire closure is opened initially, which was considerably more difficult in the known state of the art due to the variety of breaking material bridges. For example, instead of an element blocking, an element can also be used in which individual, increasingly stronger predetermined fracture points gradually break over a larger rotation angle range in order to distribute the forces as evenly as possible over the entire range. In principle, a closure according to the invention allows a decoupling of the design of the hinge element and precise coordination of the tamper-evident seal. Of course, it is advantageous if the closure remains freely rotatable in a radial direction, irrespective of whether the screw cap is in its locked opening position or closed, which is made easier by a tamper-evident seal of this type. This has the great advantage that the screw cap can be turned to a position desired by the user. In the locked position, a slight force must still be applied externally in order to enable rotation, since an increased frictional resistance between the hinge element and the base element results from the fixing of the screw cap in relation to its pivot opening. However, the increased frictional resistance is also desired so that the screw cap does not move itself in the direction of the pouring stream during pouring, caused by the gravitational force.

### SUMMARY OF THE INVENTION

According to the invention, the tamper-evident seal on the anchor ring is designed in such a way that the breakable element is broken after a relative rotational movement between the closure cap and the container of a maximum of 25°. This is generally meaningful, as it guarantees quick breaking of the tamper-evident seal. However, a solution of this type is particularly suitable in the case of a closure for a dispensing element for cardboard/plastic composite packages. There, the respective means of opening begins to attack the integrity of the package as soon as the closure cap is turned. Accordingly, it is appropriate if the tamper-evident seal has already been broken while the composite package is still sealed. A turning angle of 25° has proven to be a good measure, whereby it is preferably already broken after 20° or 15° in order to guarantee this in any case.

On the one hand, this can keep the opening forces low, but it also creates clarity for consumers. With the known closures from the prior art, especially with connected closure caps, it can often happen that individual breakable material bridges do not break completely when opened initially. These must then be broken in a further opening step by direct pulling on the screw cap that has been loosened so far, which often occurs with the usual connected caps, because the free gap- or weakening lines, as they are often called with breakable material bridges in these cases-only span a part of the cap circumference, which, as mentioned, leads to unequal force application on the individual material bridges during the initial opening. Since these breakable material bridges are omitted here, the opening behaviour of the closure is always the same. Of course, with the material bridges, the tamper-evidence seal that is usually required is lost. As described below in some embodiments of the invention, for example, a freely configurable, tamper-evident seal decoupled from the hinge element can now be used, but other solutions are also conceivable.

The object is also achieved by two alternative containers, which are also described in more detail in the figures. On the one hand, this is a combination of a closure according to the invention and a bottle, wherein the closure is attached to the bottle neck of the bottle. Alternatively, a solution is provided by a resealable pouring element for cardboard/plastic composite packages with a base element having a circumferential fastening flange, with a closure according to the invention and opening means arranged at least in the unopened state of the pouring element inside the base element, wherein a pouring opening is created within the pouring element by the opening means when the composite package is opened initially when the closing cap is unscrewed by breaking open the composite material of the package or a barrier layer located in the base element.

A further teaching of the invention provides that the anchor ring has a second free gap running in the circumferential direction, which separates the anchor ring in a section into an upper part and a lower part, wherein the upper part and the lower part are arranged spaced apart from one another in an axial direction. It is particularly advantageous if no material bridges that break between the upper and lower part are formed in the second free gap when the container is opened initially. In this case, it is advantageous if the second free gap is arranged in the circumferential direction in the region of the hinge element. In this way, the hinge element can be connected to the upper parts of the anchor ring in such manner that the upper parts are twisted after the screw cap is pivoted open.

In a particularly preferred embodiment of the invention, the second free gap is extended via a connecting piece and is connected to the free gap such that a single free gap is create, which stretches over more than one revolution. As a result, the closure only has a single upper part as a connection to the anchor ring. Such a one-sided connection of this type makes it easier to pivot the closing cap to the side after lifting it off.

According to a preferred embodiment of the invention, the entire closure is primary formed in one piece and the free gap is formed in this way. Common primary forming processes for closures include injection moulding and compression moulding or hybrid injection embossing. Particularly in injection moulding and injection embossing, free gaps according to the invention can simply be produced by means of what are known as sliders, which are moved (sideways) in the injection mould, or collets. This is a simple variant because it only involves a single production and assembly step, but more complex tools of this type will of course become more expensive.

In a particularly preferred embodiment of the invention, the closure is first formed in one piece and then the free gap is inserted with a knife. This allows for simpler and cheaper production of the closure in the primary forming step and also allows the use of production processes that cannot directly introduce free gaps, such as compression moulding. The use of a knife is the common variant and is sufficiently known from the state of the art, especially because it makes it easy to create material bridges. However, since material bridges of this type are not required according to the invention, alternative methods can also be used. For example, the closure can first be formed in one piece and then the free gap can be inserted with a laser. Other variants are also conceivable, such as ultrasound, hot air or irradiation.

According to a preferred embodiment of the invention, the free gap is introduced into the closure prior to assembly of the closure on the container neck or the base element. Assembly is the process in which the closure is applied to its counterpart, for example a bottle neck or a base element for a composite package. In the case of a base element, this step may also include the attachment of an opening element. This means that the closure is loosened, machined and then assembled and thus brought into a saleable condition. In the case of a bottle, a container filled with content and fully sealed would therefore be available after assembly, whereas a pouring element can be sold fully assembled even before it is applied to a composite package.

Alternatively, the closure is first applied to the container neck or the base element and then the closure is finished by inserting the free gap. This makes it much easier to handle the semi-finished closures before assembly. Since no weakening or possible material bridges have been introduced into the material at this point, it is possible to design the processes that occurred previously with more leeway. For example, the semi-finished closures can be transported at significantly higher speeds on belts or by air assistance without fear of damage. The assembly process itself can also be designed to be less sensitive and, for example, closures can be pressed with higher force or unscrewed in at higher speeds. In the case of a pouring element for composite packages, the free gap could even be introduced first in the applicator for pouring elements on said composite packages in order to complete the assembly of the closure with free gap there. This can be done using the same procedures already mentioned.

According to a further preferred embodiment of the invention, the anchor ring has a substantially circumferential, radially inwards-facing web at its lower end in order to prevent the anchor ring from being pulled off the container neck or base element. The container neck or the base element naturally has a corresponding outwardly protruding and substantially circumferential collar on the outside. At least either the collar or the web can also be interrupted at one or more points, provided that it is ensured that the anchor ring with its web pointing towards the base element cannot slide over the collar provided on the base element.

In a further embodiment of the invention, the tamper-evident seal is preferably formed as at least one protruding tamper-evident seal, which, apart from the breakable element to the anchor ring, is additionally firmly connected to the closure at one end. This can consist of a strip, whose one end is firmly connected to the anchor ring and in the case of which the other end is connected to the anchor ring by means of a breakable element in such a manner that the breakable element of at least one peg element arranged on the fastening flange is broken open when the screw cap is unscrewed and thus indicates to the consumer that an initial opening has already taken place.

According to a further embodiment of the closure according to the invention, another ring is arranged below the anchor ring, which is connected to the anchor ring via a plurality of material bridges and serves as a tamper-evident seal. Here, the screw cap, the anchor ring and the additional ring serving as an tamper-evident seal are manufactured in one piece. Preferably, the ring can only be twisted to a limited extent by blocking webs protruding inwards from the ring with locking elements arranged over the circumference of the base element such that it is released from the anchor ring when the screw cap is unscrewed initially by tearing off the material bridges and remains in its position on the base element. This is also helpful if the tamper-evident seal, which is thus decoupled from the connection function, breaks quickly so that the rest of the opening process can be performed without problems. In order to ensure that the ring cannot be removed from the container even when the screw cap is open, usually on the outside of the container an outwardly protruding and substantially circumferential collar is formed, wherein the clear inner diameter of the collar is smaller than the clear distance between the webs of the ring arranged opposite in each case.

In a particularly preferred embodiment of the invention, the cap is designed as a screw cap with an internal thread. The traditionally known variant of a screw cap allows easy and familiar operation by consumers and also simple assembly, for example by linear pressing or even unscrewing of the closure and corresponding counterpart.

According to a further embodiment of the closure according to the invention, the inside of the cap jacket is provided with elements in such a way that a bayonet closure is formed on the container in such a way that the closing cap moves on a clearly defined path when actuated. This allows significantly more design freedom for the other elements associated with the closure, such as the opening means of a pouring element, and enables opening over a significantly shortened opening distance, usually in the range of 60° to 120° rotation.

### BRIEF DESCRIPTION OF THE DRAWINGS

The drawing shows

FIG. 1 a first exemplary embodiment of a closure in the form of a pouring element according to the invention in an unopened state (without cardboard/plastic composite package) in perspective representation,

FIG. 2 the pouring element from FIG. 1 in a side view,

FIG. 3 a base element of the pouring element from FIG. 1 in perspective representation,

FIG. 4 the pouring element from FIG. 1 in the vertical section along the line IV-IV,

FIG. 5 the pouring element from FIG. 1 at the start of the unscrewing process of the screw cap in perspective view,

FIG. 6 the pouring element from FIG. 1 with screw cap already unscrewed but still closed in a side view in half-section,

FIG. 7 the pouring element from FIG. 1 with unscrewed and pivoted-away screw cap in a side view,

FIG. 8 the pouring element from FIG. 1 with unscrewed, pivoted-away and locked screw cap in a side view,

FIG. 9 a second exemplary embodiment of a closure in the form of a pouring element according to the invention in an unopened state (without cardboard/plastic composite package) in perspective representation,

FIG. 10 the pouring element from FIG. 9 in the vertical section along the line X-X,

FIG. 11 the pouring element from FIG. 9 in a horizontal section along the line XI-XI from FIG. 10,

FIG. 12 the pouring element from FIG. 9 with screw cap already unscrewed but still closed in a side view in half-section along the line XII-XII from FIG. 11 and

FIG. 13 a further embodiment of a closure according to the invention in combination with a bottle neck of a bottle-shaped container in a side view.

### DESCRIPTION OF THE INVENTION

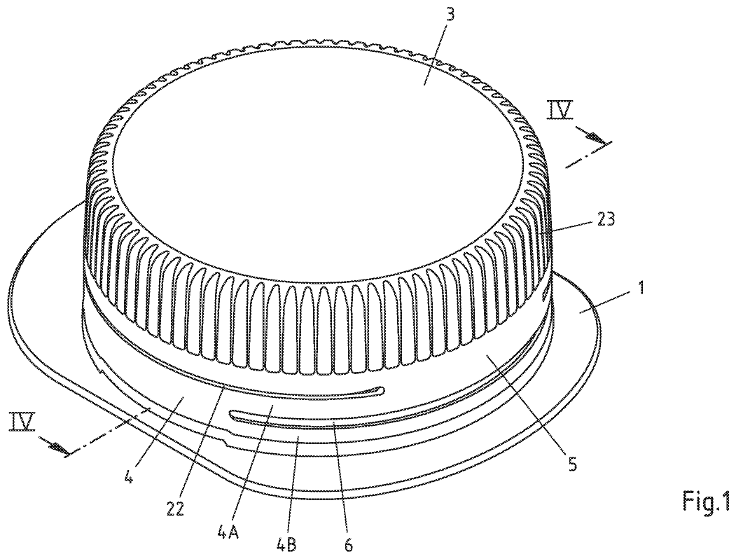

A preferred embodiment of a closure according to the invention in combination with a container neck is shown in the drawing. In order to clarify the mode of operation of the invention in a complete system, a resealable pouring element comprising the closure according to the invention is described below. FIG. 1 represents a pouring element without composite package in perspective view. The pouring element has a base element 2 having a circumferential fastening flange 1 (which is not visible in FIG. 1) and a screw cap 3, which is used for the initial opening and resealing of a composite package not represented.

An anchor ring 4 is arranged below the screw cap 3 and is connected thereto in a rotationally-fixed manner in order to reliably prevent the screw cap 3 from being removed from the base element 2 or from a composite package provided therewith. For this purpose, the screw cap 3 and the anchor ring 4 are connected to one another in a hinged manner via a hinge element 5, whose pivot axis is aligned tangentially to the outer circumference of the screw cap 3. A free gap 22 can also be seen between the anchor ring 4 and a cap jacket 23 of the screw cap 3. The free gap 22 extends in the circumferential direction around a large part of the circumference of the screw cover 3, wherein it is merely interrupted by the hinge element 5. The free gap 22 thus connects on both sides next to the hinge element 5. In other words, the free gap 22 and hinge element 5 clamp together the entire circumference of the locking cap in this case. The anchor ring 4 also has a second free gap 6 running in the circumferential direction, which separates the anchor ring 4 in a section into upper parts 4A and a lower part 4B, wherein the upper parts 4A and the lower part 4B are arranged spaced apart from one another in the axial direction. The hinge element 5 can be designed with a larger, identical or even smaller wall thickness compared to the rest of the screw cap 2.

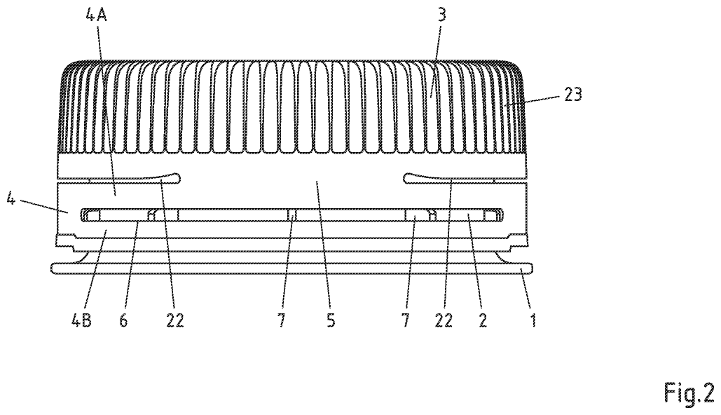

It is clearly discernible in FIG. 2 that the second free gap 6 is arranged centrally to the hinge element 5 in the circumferential direction. The hinge element 5 is connected to the upper parts 4A of the anchor ring 4 and arranged above the lower third of the base element 2 in relation to its pivot axis in the unopened state. In addition, FIG. 2 shows that the free gap 22 and the second free gap 6 are each arranged overlapping one another over a certain angle range, which is why the upper parts 4A are created. Furthermore, ribs 7 protruding outwards in the direction of the anchor ring 4 and extending perpendicular to the fastening flange 1 are provided on the lower region of the base element 2. These center the anchor ring 4 in relation to the base element 2 and ensure uniform friction when twisting the anchor ring 4.

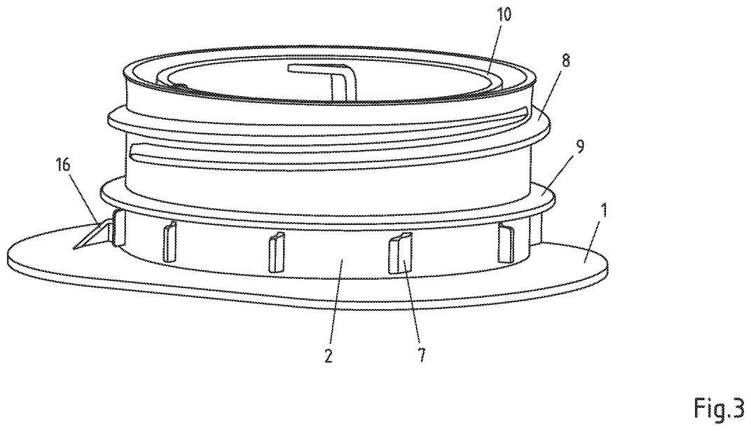

FIG. 3 shows the base element 2 of the pouring element represented in FIG. 1. It can be seen that the base element 2 has an external thread 8 by means of which the screw cap 3 not represented in FIG. 3 can be screwed onto the base element 2. The base element 2 also has an outwardly protruding and radially circumferential collar 9 on its outer side above the ribs 7.

Furthermore, a cutting element 10 is discernible in the interior of the base element 2, which creates a pour opening within the pouring element when the composite package is opened initially by unscrewing the screw cap 3.

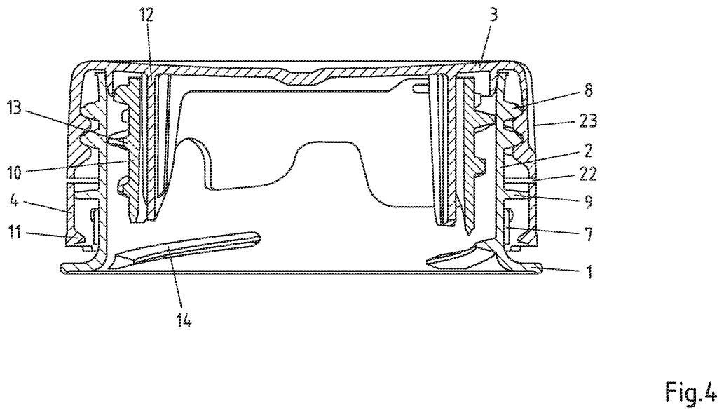

FIG. 4 now represents the pouring element in the vertical section in the unopened state. It can be seen in FIG. 4 that the collar 9 with its outer circumferential surface in the upper region of the anchor ring 4 touches the inner surface of the anchor ring 4. The anchor ring 4 has, at its lower end, a radially circumferential web 11 which is directed towards the base element 2 and which is arranged below the collar 9 provided on the base element 2. This prevents the anchor ring 4 from being pulled off beyond the collar 9. The collar 9 is arranged in the unopened state of the pouring element in the upper region of the anchor ring 4 such that when the screw cap 3 is unscrewed, the movement of the anchor ring 4 and thus also of the hinge element 5 is enabled upwards in the axial direction until the web 11 comes into contact with the collar 9.

In the preferred embodiment shown in FIG. 4, an opening means is discernible, consisting of the cutting element 10 arranged in the interior of the base element 2 and driver webs 12, which are arranged in the interior of the screw cap 3 and which are connected thereto in a materially-bonded manner. When the composite package is opened initially, the cutting element 10 having an external thread 13 is carried by means of the driver webs 12 and an internal thread 14 formed on the base element 2 by unscrewing the screw cap 3 in the direction of the composite package such that a pour opening is created within the pouring element. It is clearly discernible that the driver webs 12 protrude downwards in comparison to the outer circumferential surface of the screw cap 3 such that they protrude from the interior of the screw cap 3 in the pivoted-open state.

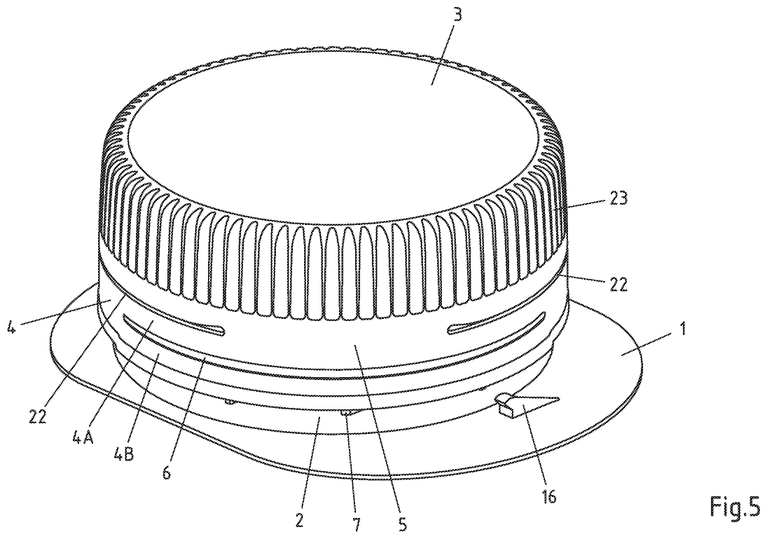

FIGS. 5 to 8 lastly illustrate the function of the pouring element during the opening process of the screw cap 3.

FIG. 5 shows the pouring element at the start of the unscrewing process of the screw cap 3. Here, it can be seen that the anchor ring 4 is connected to the base element 2 so as to be radially freely rotatable such that the anchor ring 4 moves with the rotational movement of the screw cap 3.

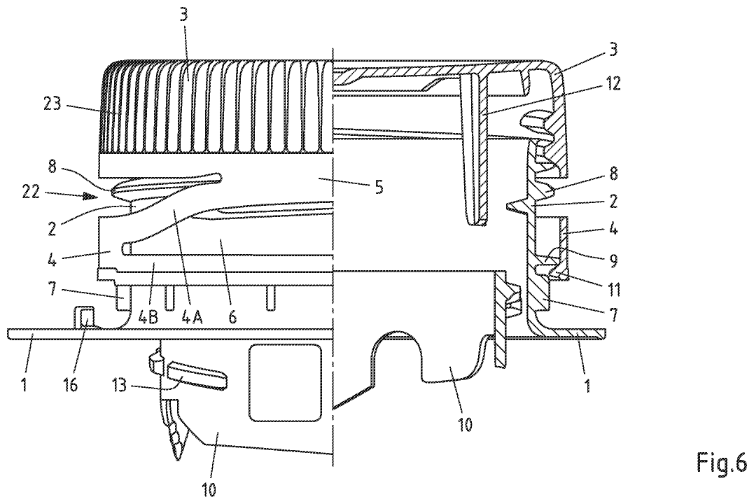

FIG. 6 shows the pouring element with screw cap 3 already unscrewed but still closed. On the left side of FIG. 6, the pouring element is shown in a side view, while the right side of FIG. 6 shows a vertical section. The anchor ring 4 and thus the hinge element 5 have also moved upwards due to the upwards movement of the screw cap 3. In this state, the collar 9 provided on the base element 2 and the web 11 arranged on the anchor ring touch one another. The second free gap 6 has been enlarged at least centrally in the axial direction as a result of the screw cap 3 being carried upwards such that the pivot axis of the hinge element 5 has moved further upwards in the axial direction. The free gap 22, on the other hand, only allows the subsequent pivoting away of the screw cover 3 because it extends over a large part of the circumference.

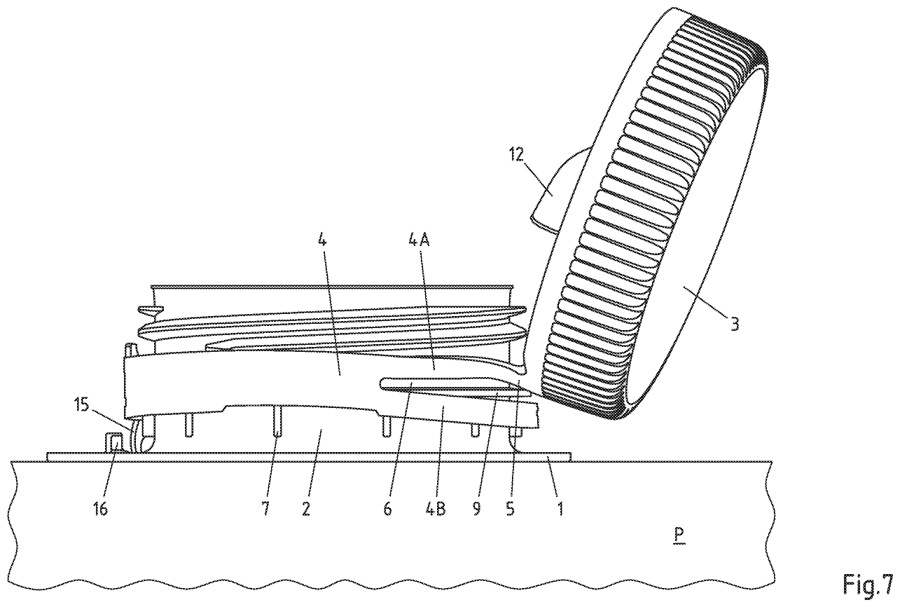

FIG. 7 represents the pouring element in an opened state and with a pivoted-away screw cap 3 with a composite package. Like in FIG. 6, it can also be seen here that the anchor ring 4 cannot slide over the collar 9 such that it is connected in a tension-resistant manner to the base element 2 in an axial direction in spite of its rotatability in relation to the base element 2. As a result, the anchor ring 4 and thus also the screw cap 3 being pulled off is reliably prevented.

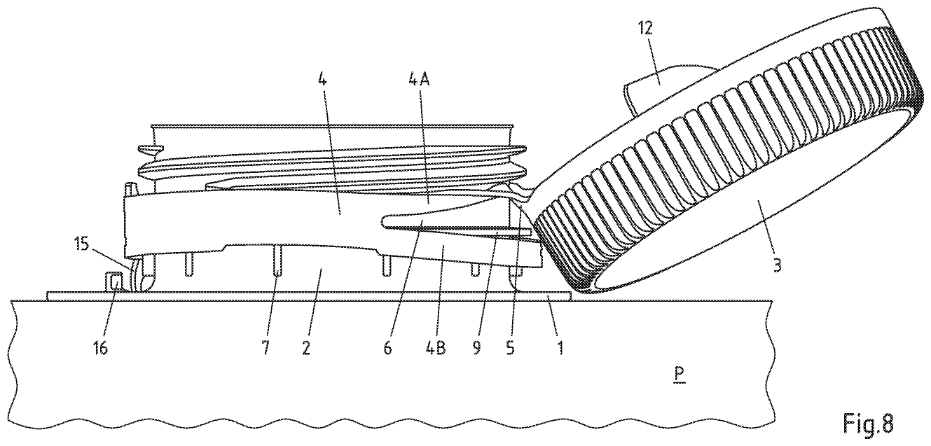

In addition, it emerges from FIG. 7 that by pivoting open the screw cap 3, the upper parts 4A of the anchor ring 4 twist at their one end, which establish a connection to the hinge element 5, but do not tear off. The hinge element 5 rotates by pivoting open the screw cap 3 in the direction of the second free gap 6 until it is folded over as shown in FIG. 8 such that it is locked in its opening position at an opening angle of 120° to 150° in relation to its pivot opening. In its locked opening position, the screw cap 3 is still radially freely rotatable, if a certain force must be applied externally due to an increased frictional resistance in order to enable rotation.

It can be clearly seen from FIGS. 7 and 8 that driver webs 12 of the opening means protrude from the interior of the screw cap 3 in the pivoted-open state.

Furthermore, it can be inferred from FIGS. 7 and 8 that attached to the anchor ring 4 is a strip 15 serving as a tamper-evident seal, whose one end is firmly connected to the anchor ring 4 and in the case of which the other end is connected to the anchor ring 4 by means of a predetermined breaking point in such manner that the predetermined breaking point is broken open by a peg element 16 arranged on the fastening flange 1 when the screw cap 3 is unscrewed initially.

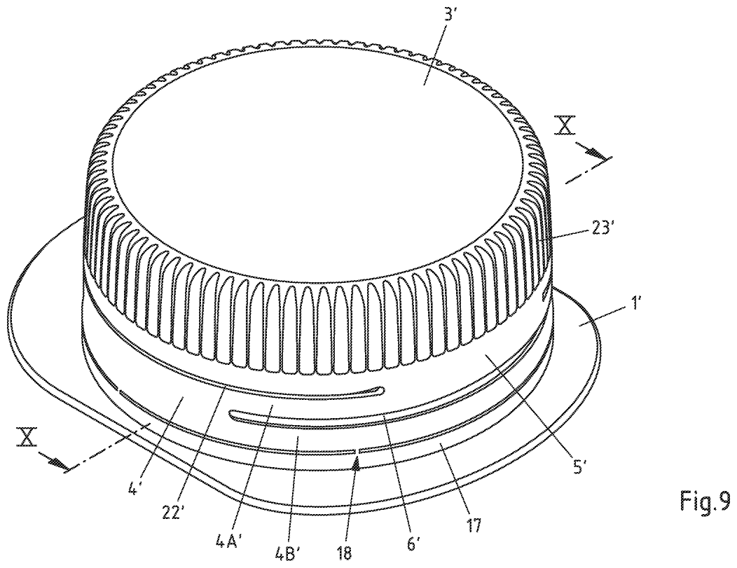

FIG. 9 shows a further exemplary embodiment of a pouring element without composite package in perspective view. This pouring element has, as in the first exemplary embodiment according to FIG. 1, a circumferential fastening flange 1′ and a screw cap 3′. An anchor ring 4′ is located below the screw cap 3′ and is connected thereto in a rotationally-fixed manner as in the case of the first exemplary embodiment in order to fasten the screw cap 3′ to the base element (not discernible in FIG. 9). The embodiment of screw cap 3′ and the anchor ring 4′ located therebelow correspond exactly to the first exemplary embodiment from FIG. 1.

However, in the case of this exemplary embodiment, another ring 17 is located below the anchor ring 4′ and is connected to the anchor ring 4′ in one piece with a plurality of material bridges 18.

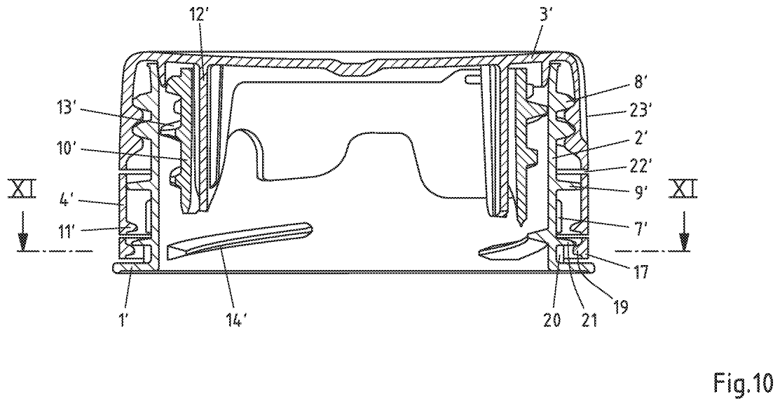

FIG. 10 initially corresponds substantially to the vertical section according to FIG. 4 such that reference can be made to the description of the screw cap 3′, the anchor ring 4′ and the cutting element 10′. However, the (other) ring 17 can clearly be seen below the anchor ring 4′ and is designed as a tamper-evident seal. For this purpose, the ring 17 has a plurality of webs 19 arranged distributed over the circumference and protruding inwards, which come into contact with corresponding locking elements 20 proceeding from the base element 2′ when the screw cap 3′ is unscrewed initially and they block the further rotation of the ring 17, as described in more detail below.

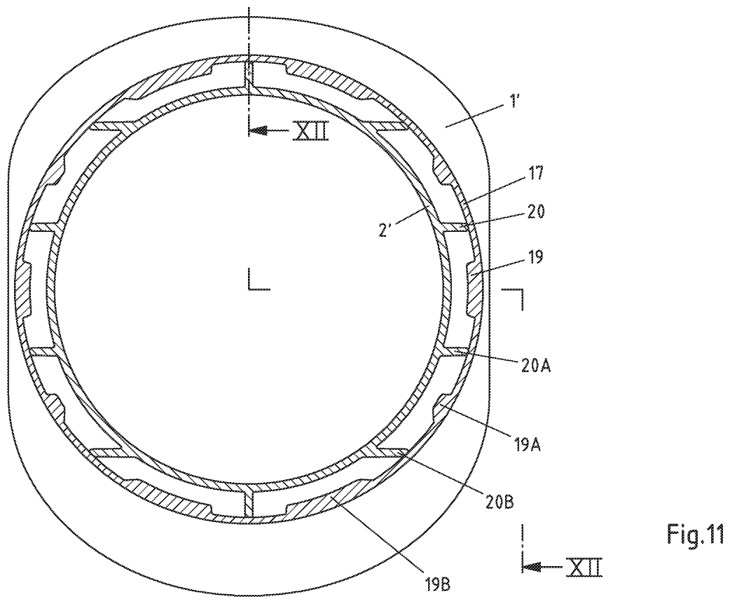

FIG. 11 represents the pouring element from FIG. 9 in the horizontal section along the line XI-XI from FIG. 10. Here, the circumferential ring 17 can be clearly seen, from which proceed a plurality of inwardly protruding webs 19, 19A and 19B. In order to ensure that the ring 17 does not rotate with the anchor ring 4′ when unscrewing the screw cap 3′, the base element 2′ has a plurality of outwardly protruding locking elements 20, 20A and 20B, which interact with the aforementioned webs 19, 19A and 19B such that the ring 17 blocks when unscrewed such that the material bridges 18 arranged thereabove are initially stretched and then tear off, thus no longer hindering the further rotation of the anchor ring 4′.

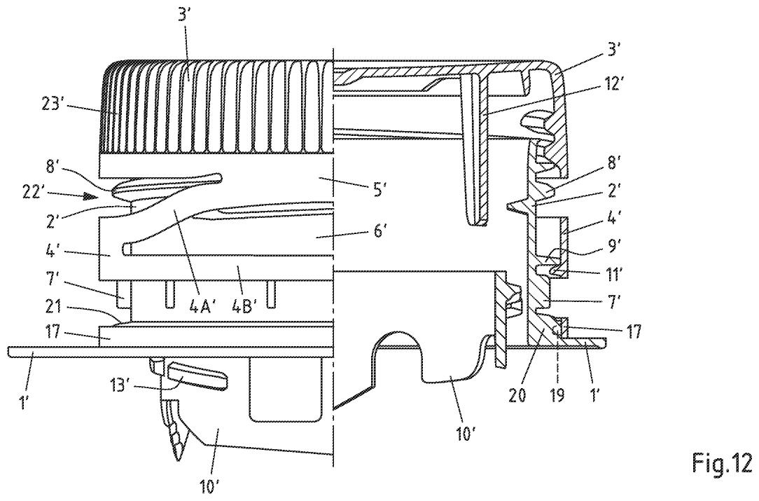

It clearly emerges from FIGS. 11 and 12 that the base element 2′ has an outwardly protruding and substantially circumferential collar 21 on its outer side, wherein the clear inner diameter of the collar 21 is smaller than the clear distance between the webs 19 of the ring 17 arranged opposite in each case. This reliably prevents the ring 17 from moving out of its lower position 17 on the base element 2′ even when the screw cap is unscrewed. This ensures that the ring 17 cannot enter the environment as a “loose plastic part”.

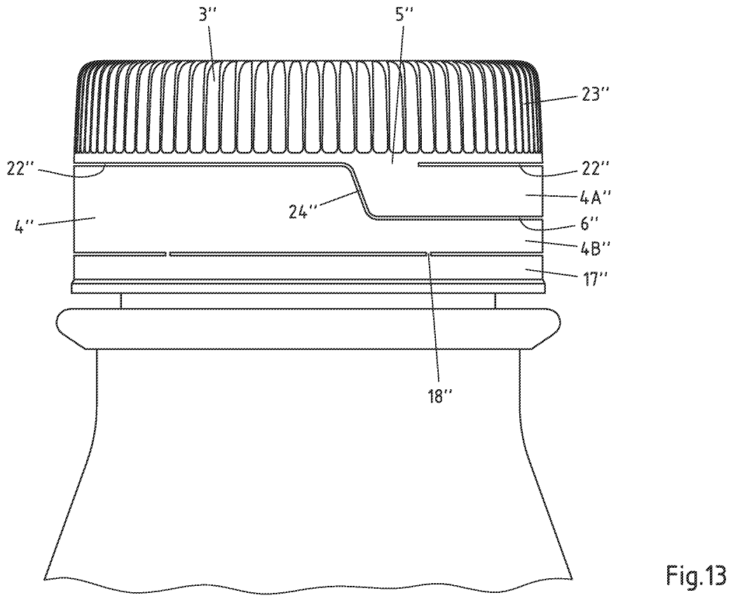

A further embodiment of a closure according to the invention in combination with a bottle neck is shown in the FIG. 13. This is the neck of a beverage bottle, which in this variant is no longer formed as the base element of a separate pouring element. Accordingly, the screw cap 3″ can be designed in a much simpler and cheaper manner, as no opening means are required. A second ring 17″ is used as a tamper-evident seal. The second free gap 6″ is connected to the free gap 22″ via a connection piece 24″ in such a way that a single free element is created which stretches over more than one revolution. Elements (not shown here) comparable to the external thread 8, the collar 9 and at least the collar 21 of the previous embodiments can of course also be found on the bottle neck.

In particular, the different designs of tamper-evident seals and hinge elements are conceivable in many other combinations without diverting from the idea of invention. In addition to the elements already shown in the figures, a hinge element could, for example, also be designed as a single or multi-part, radially outwardly protruding hinge, which connects the anchor ring and closing cap to one another. Various other variants are known from the state of the art, such as a hinge element made of an elastomer or one which also has a tab protruding downwards. These possibilities are also independent of whether the closure is used for a pouring element as in the first two embodiments described or for a bottle neck as in the third embodiment.

1. A closure for a container, in particular a bottle or a cardboard/plastic composite package, comprising a base element, comprising a rotatably opening cap with lateral cap jacket, an anchor ring connected to the cap jacket in an articulated manner via a hinge element and a free gap running in a substantially circumferential direction between the anchor ring and the cap jacket, wherein the free gap connects on both sides next to the hinge element and wherein in the free gap there are no material bridges between the anchor ring and closure cap that can be broken upon initial opening, characterised in that
the closure comprises a tamper-evident seal which, in the unopened state, is connected to the anchor ring via at least one breakable element and in that the tamper-evident seal on the anchor ring is designed in such a way that the at least one breakable element is broken after a relative rotational movement between the sealing cap and container of a maximum of 25°.

2. The closing according to claim 1,
wherein
the at least one breakable element is broken after a relative rotational movement between closing cap and container of a maximum of 20°.

3. The closure according to claim 1,
wherein
the at least one breakable element is broken after a relative rotational movement between closing cap and container of a maximum of 15°.

4. The closure according to claim 1,
wherein
the anchor ring having a second free gap running in the circumferential direction, which separates the anchor ring in a section into an upper part and a lower part, wherein the upper part and the lower part are arranged spaced apart from one another in the axial direction.

5. The closure according to claim 4,
wherein
no material bridges that break between the upper and lower part are formed in the second free gap when the container is opened initially.

6. The closure according to claim 4,
wherein
the second free gap is arranged in a circumferential direction in the region of the hinge element, wherein the hinge element is connected to two upper parts of the anchor ring in such a way that the upper parts are twisted after the closing cap is pivoted open.

7. The closure according to claim 4,
wherein
the second free gap is extended via a connecting piece and is connected to the free gap such that a single free gap is create, which stretches over more than one revolution.

8. The closure according to claim 1,
wherein
the entire closure is formed in one piece and the free gap is formed in this way.

9. The closure according to claim 1,
wherein
initially the closure is formed in one piece and the free gap is inserted using a knife.

10. The closure according to claim 1,
wherein
initially formed in one piece and the free gap is inserted with a laser.

11. The closure according to either claim 9,
wherein
the free gap is introduced into the closure before assembly on the container neck or the base element or in that the closure is first applied to the container neck or the base element and the closure is then finished by introducing the free gap.

12. The closure according to any one-of-claim 1,
wherein
the anchor ring has, at its lower end, a substantially circumferential web directed radially inwards in order to prevent the anchor ring from being pulled off the container.

13. The closure according to claim 1,
wherein
the tamper-evident seal is preferably formed as at least one protruding tamper-evident seal, which, apart from the breakable element to the anchor ring, is also firmly connected to the closure at one end.

14. The closure according to claim 1,
wherein
the tamper-evident seal is designed as a further ring below the anchor ring, which is connected to the anchor ring via a plurality of breakable material bridges.

15. The closure according to claim 1,
wherein
the closure cap is designed as a screw cap with an internal thread.

16. The closure according to claim 1,
wherein
the inner side of the cap jacket is provided with elements in such a way that a bayonet closure is formed on the container in such a way that the closing cap moves on a clearly defined path when actuated.

17. A combination of a closure according to claim 1 and a bottle, wherein the closure is attached to the bottle neck of the bottle.

18. A reclosable pouring element for cardboard/plastic composite packages having with a base element comprising a circumferential fastening flange, having a closure according to claim 1 and opening means, arranged in the interior of the base element, at least in the unopened state of the pouring element, wherein a casting opening is created inside the pouring element by the opening means when the composite package is first opened when the closing cap is unscrewed by breaking open the composite material of the package or a barrier layer located in the base element.
